(19) United States
(12) Patent Application Publication
(10) Pub. No.: US 2026/0014936 A1
(43) Pub. Date: Jan. 15, 2026

(54) BIDIRECTIONAL OPENING CONSOLE

(71) Applicants: HYUNDAI MOTOR COMPANY, Seoul (KR); KIA CORPORATION, Seoul (KR); NIFCO KOREA INC., Asan-si (KR)

(72) Inventors: Cheon Ho KIM, Hwaseong-si (KR); Byoung Wook KIM, Hwaseong-si (KR); Jung Yoon JANG, Hwaseong-si (KR); Hong Sik CHANG, Hwaseong-si (KR); Hyo Keun YANG, Asan-si (KR); Ju Sung PARK, Asan-si (KR)

(73) Assignees: HYUNDAI MOTOR COMPANY, Seoul (KR); KIA CORPORATION, Seoul (KR); NIFCO KOREA INC., Asan-si (KR)

(21) Appl. No.: 18/957,988

(22) Filed: Nov. 25, 2024

(30) Foreign Application Priority Data
Jul. 10, 2024 (KR) 10-2024-0090836

(51) Int. Cl. B60R 7/04

(52) U.S. Cl. CPC B60R 7/04

(57) ABSTRACT

A bidirectional opening console including side lid parts located on opposite sides of the console, a center lid part located between the side lid parts, button units located at front and rear ends of the center lid part, a rod unit moved in a longitudinal direction of the side lid parts in response to an input applied to the button units, a lock member unit located at the center lid part and configured to release coupling with the side lid parts in response to movement of the rod unit, and a locking cam unit rotated by the movement of the rod unit, wherein the lock member unit at the other end of the center lid part maintains a coupled state thereof by rotation of the locking cam unit, wherein the other end is located away from the button unit having the input applied thereto.

### CROSS-REFERENCE TO RELATED APPLICATION

This application claims, under 35 U.S.C. § 119(a), the benefit of priority from Korean Patent Application No. 10-2024-0090836, filed on Jul. 10, 2024, the entire contents of which are incorporated herein by reference.

### BACKGROUND

### (a) Technical Field

The present disclosure relates to a bidirectional opening console, and more particularly, to a device configured to implement a structure that enables a vehicle console to be selectively opened and closed from the front side of the vehicle console and the rear side thereof.

### (b) Background Art

Generally, a console box is installed between the driver's seat and the passenger seat of a vehicle. This console box is formed of a storage box installed at a lower portion and a console configured to open and close an upper portion of the storage box. The console box is further formed of side lids provided on opposite sides and fixed to the storage box installed at the lower portion and a center lid installed between the side lids and configured to be openable and closable.

The center lid of the console box opens and closes a storage space formed in the storage box with respect to the fixed side lids. Generally, since the console box is mainly used in the driver's seat, the same is designed to be opened only in one direction from the front side to the rear side.

The console is configured to be operated by pressing a button only in the first row seat. That is, the console is configured to be opened and closed only from the front side by a driver sitting on the driver's seat or a passenger sitting on the passenger's seat in the first row seat.

Therefore, a passenger sitting in the second row seat may not store an item in the console or may not use an item stored therein.

In this manner, the console is designed to be opened only from the front side, which makes it difficult for all passengers in the vehicle to use the console.

In order to solve the above-described problems, a console configured to be selectively opened from the front side or the rear side is disclosed in Korean Utility Model No. 20-0136941 (registered on Nov. 17, 1998) and Korean Patent No. 10-0930757 (registered on Dec. 1, 2009).

Meanwhile, in addition to the above-mentioned related art, recently, consoles capable of being selectively opened and closed from both sides have been released. However, according to the console configuration described in the related art documents, the console is configured to be simultaneously opened from the front side and the rear side, which may cause injury to a passenger. Furthermore, it is difficult to manufacture the console due to a complicated structure thereof.

In addition, there is an additional problem in that such complicated structure requires many components, leading to deterioration in exterior design of the console.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a bidirectional opening/closing vehicle console capable of being opened and closed from a front side and a rear side thereof, wherein the bidirectional opening/closing vehicle console is configured to stably fix the rear side when the front side is opened or closed and to stably fix the front side when the rear side is opened or closed, thereby making it possible not only to prevent the front side and the rear side of the console from being simultaneously opened, but also to eliminate inconvenience caused to a passenger.

Another object of the present disclosure is to provide a bidirectional opening and closing vehicle console capable of being opened and closed in both directions with a simple configuration and simple components, thereby improving aesthetics of the exterior of the vehicle console.

The objects of the present disclosure are not limited to the above-mentioned objects, and other technical objects not mentioned herein will be clearly understood by those skilled in the art to which the present disclosure pertains from the detailed description of the embodiments. Additionally, the objects of the present disclosure may be achieved by means and combinations thereof as indicated in the claims.

In one aspect, the present disclosure provides a bidirectional opening console including side lid parts respectively located on opposite sides of the console, a center lid part located between the side lid parts, wherein the center lid part is opened with respect to one end thereof, button units respectively located at a front end of the center lid part and a rear end thereof, a rod unit configured to be moved in a longitudinal direction of the side lid parts in response to an input applied to one of the button units, a lock member unit located at the center lid part and configured to release coupling with each of the side lid parts in response to movement of the rod unit, and a locking cam unit configured to be rotated by the movement of the rod unit, wherein the lock member unit disposed at the other end of the center lid part maintains a coupled state thereof by rotation of the locking cam unit, wherein the other end is located away from the button unit having the input applied thereto.

In an embodiment, the button unit may include a first lock housing having a hollow formed therein, a first rod lock inserted into the hollow of the first lock housing, a first elastic member located around an outer circumferential surface of the first rod lock and configured to impart elasticity to the first rod lock, and a first rod lock member connected to the first rod lock and coupled to the rod unit when the first rod lock is moved downwards.

In another embodiment, the first rod lock member may fix, when one side of the console is opened, the movement of the opened rod unit.

In still another embodiment, the first rod lock member may be formed to have a hook shape and may be caught by a first rod, and the first rod may have a shape corresponding to a groove shape of a slider.

In yet another embodiment, the rod unit may include a first rod located at the front end of the console, a second rod located at the rear end of the console, and a slider configured to be moved integrally with the first rod, the slider having a groove formed in a rear surface thereof.

In still yet another embodiment, the lock member unit may include first lock members located at the front end of the console, wherein each of the first lock members is locked to or unlocked from a corresponding one of the side lid parts, and second lock members located at the rear end of the console, wherein each of the second lock members is locked to or unlocked from a corresponding one of the side lid parts.

In a further embodiment, the locking cam unit may include a first locking cam having a protrusion formed on an outer circumferential surface thereof, and a second locking cam configured to allow the protrusion of the first locking cam to be inserted into an inner circumferential surface thereof, the second locking cam having a groove continuously formed along the inner circumferential surface, wherein when the first locking cam is rotated in response to longitudinal movement of the rod unit at the front end, the second locking cam may be moved in a direction away from the first locking cam, and when the second locking cam is rotated in response to longitudinal movement of the rod unit at the rear end, the first locking cam may be moved in a direction away from the second locking cam.

In another further embodiment, the locking cam unit may include a locking cam housing configured to accommodate a first locking cam and a second locking cam, and a cam spring configured to impart elasticity to the first locking cam and the second locking cam in a direction allowing the first locking cam and the second locking cam to be adjacent to each other.

In still another further embodiment, the first locking cam may include a first locking member formed to protrude and extend from the outer circumferential surface of the first locking cam by a predetermined amount and selectively coupled to the rod unit, a first step located adjacent to the first locking member, wherein the first step converts, in response to the longitudinal movement of the rod unit, movement of the first locking cam into rotational motion of the first locking cam, an extension member located on one surface of the first locking cam and formed to extend toward an inner side of the second locking cam, and a protrusion formed to protrude from an outer circumferential surface of the extension member.

In yet another further embodiment, the second locking cam may include a second locking member formed to protrude and extend from an outer circumferential surface of the second locking cam by a predetermined amount and selectively coupled to the rod unit, a second step located adjacent to the second locking member, wherein the second step converts, in response to the longitudinal movement of the rod unit, movement of the second locking cam into rotational motion of the second locking cam, and a diagonal groove configured to contact the protrusion of the extension member and formed to extend in a diagonal direction along the inner circumferential surface of the second locking cam.

In still yet another further embodiment, when the protrusion is rotated along the diagonal groove, the second locking cam may be moved in a width direction away from the first locking cam, and the second locking member may be coupled to a second groove located in the second rod so as to restrict movement of the second rod.

In a still further embodiment, when the second locking cam is rotated, the protrusion may be moved integrally with the first locking cam along the diagonal groove in a width direction away from the second locking cam, and the first locking member may be coupled to a first groove located in the first rod so as to restrict movement of the first rod.

In a yet further embodiment, the second rod may be located in contact with the button unit.

In a still yet embodiment, the button unit may include a second lock housing positioned at a rear end of the console, the second lock housing having a hollow formed therein, a second rod lock inserted into the hollow of the second lock housing, and a second elastic member located on an outer circumferential surface of the second rod lock and configured to impart elasticity to the second rod lock, wherein the rod unit may have a groove formed therein and configured to allow one side of the second rod lock to be inserted thereinto, and the second rod lock may be moved downwards by the elasticity of the second elastic member so as to be fixedly inserted into the groove.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1A is a view showing a state in which a console is opened with respect to a front end of a center lead part according to an embodiment of the present disclosure;

FIG. 1B a view showing a state in which the console is opened with respect to a rear end of the center lead part according to the embodiment of the present disclosure;

FIG. 2A is a view showing a state in which a button unit located at the front end of the center lead part is not pressed according to the embodiment of the present disclosure;

FIG. 2B is a view showing a state in which the button unit located at the front end of the center lead part is pressed and the console is unlocked;

FIG. 3A is a view showing a state in which a button unit located at the rear end of the center lead part is not pressed according to the embodiment of the present disclosure;

FIG. 3B is a view showing a state in which the button unit located at the rear end of the center lead part is pressed and the console is unlocked;

FIG. 4 is a view showing a state in which a first rod and a second rod of a rod unit according to the embodiment of the present disclosure are coupled to a locking cam unit;

FIG. 5 is a view showing the locking cam unit according to the embodiment of the present disclosure;

FIG. 6A is a view showing a state in which the first rod and the second rod of the rod unit according to the embodiment of the present disclosure are respectively coupled to a first locking cam and a second locking cam of the locking cam unit and are not operated;

FIG. 6B is a view showing a state in which the first rod and the second rod of the rod unit according to the embodiment of the present disclosure are respectively coupled to the first locking cam and the second locking cam of the locking cam unit and are operated;

FIG. 7A is a view showing a cross section taken along the line A-A′ in FIG. 6A;

FIG. 7B is a view showing an operating state at the cross section taken along the line A-A′ in FIG. 6A;

FIG. 7C is a view showing a cross section taken along the line B-B′ in FIG. 6;

FIG. 7D is a view showing a rotating state at the cross section taken along the line B-B′ in FIG. 6;

FIG. 8 is a view showing the first locking cam and the second locking cam of the locking cam unit according to the embodiment of the present disclosure;

FIG. 9A is a view showing a movement direction of the locking cam unit when the first rod is operated;

FIG. 9B is a view showing a movement direction of the locking cam unit when the second rod is operated;

FIG. 10 is a view showing a structure in which the rod unit, the button unit, and the locking cam unit located in the direction of the front end of the center lead part according to the embodiment of the present disclosure are coupled to each other;

FIG. 11A is a cross-sectional view of a structure in which the button unit and the rod unit located in the direction of the front end of the center lead part according to the embodiment of the present disclosure are coupled to each other;

FIG. 11B is a perspective view of the button unit;

FIG. 12A is a cross-sectional view showing a state in which the button unit located in the direction of the front end of the center lead part according to the embodiment of the present disclosure is not pressed;

FIG. 12B is a cross-sectional view showing a state in which the button unit located in the direction of the front end of the center lead part according to the embodiment of the present disclosure is pressed;

FIG. 13 is a view showing a structure in which the rod unit, the button unit, and the locking cam unit located in the direction of the rear end of the center lead part according to the embodiment of the present disclosure are coupled to each other;

FIG. 14A is a cross-sectional view showing a structure in which the button unit and the rod unit located in the direction of the rear end of the center lead part according to the embodiment of the present disclosure are coupled to each other;

FIG. 14B is a perspective view of the button unit;

FIG. 15A is a cross-sectional view showing a state in which the button unit located in the direction of the rear end of the center lead part according to the embodiment of the present disclosure is not pressed; and

FIG. 15B is a cross-sectional view showing a state in which the button unit located in the direction of the rear end of the center lead part according to the embodiment of the present disclosure is pressed.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as “part”, “unit”, and “lead part” described in the specification mean a unit configured to process at least one function or operation, and the unit may be implemented by hardware or a combination of pieces of hardware.

The terms used in the specification are merely used to describe specific embodiments and are not intended to limit the embodiments. Singular forms are intended to include plural forms as well, unless the context clearly indicates otherwise.

Meanwhile, in this specification, terms such as “one end” and “the other end” are used to describe various components having the same names, and the terms are used only for the purpose of distinguishing one component from other components. The components are not limited by the terms in the following description.

In addition, a configuration of a movable “unit” or “part” in this specification is a configuration capable of being restored after being moved. Since the configuration may include an elastic member or a separate driving unit, expression of “restored” below may be interpreted as including all driving relationships.

Further, in this specification, a “longitudinal direction” may mean a forward-and-rearward direction of a vehicle or a console 10, and a “width direction” may mean an axial direction of the vehicle or the console 10. Meanwhile, the longitudinal direction and the width direction simply mean directions that are perpendicular to each other, and in the specification, both ends of a center lid part may be selectively opened with respect to one end of the center lid part in the longitudinal direction or the axial direction.

Furthermore, the longitudinal direction means a direction moving in one direction of the center lead part, and the width direction means a direction perpendicular to the longitudinal direction of the center lead part on the plane.

In the specification below, although a selected end (for example, one end) in the longitudinal direction of the center lead part is configured to be opened with respect to a non-selected end (for example, the other end) in the longitudinal direction of the center lead part, a selected end (for example, one end) in the width direction of the enter lead part may be configured to be opened with respect to a non-selected end (for example, the other end) in the width direction of the center lead part.

The present disclosure relates to a console 10 capable of being opened in both directions and includes a configuration in which a center lid part 500 is opened in both directions with respect to side lid parts 400 respectively located on opposite sides of the upper portion of a console housing. Further, the present disclosure relates to the bidirectional opening console 10 configured such that the center lid part 500 is rotatably opened with respect to a front end of the center lid part 500 or a rear end thereof.

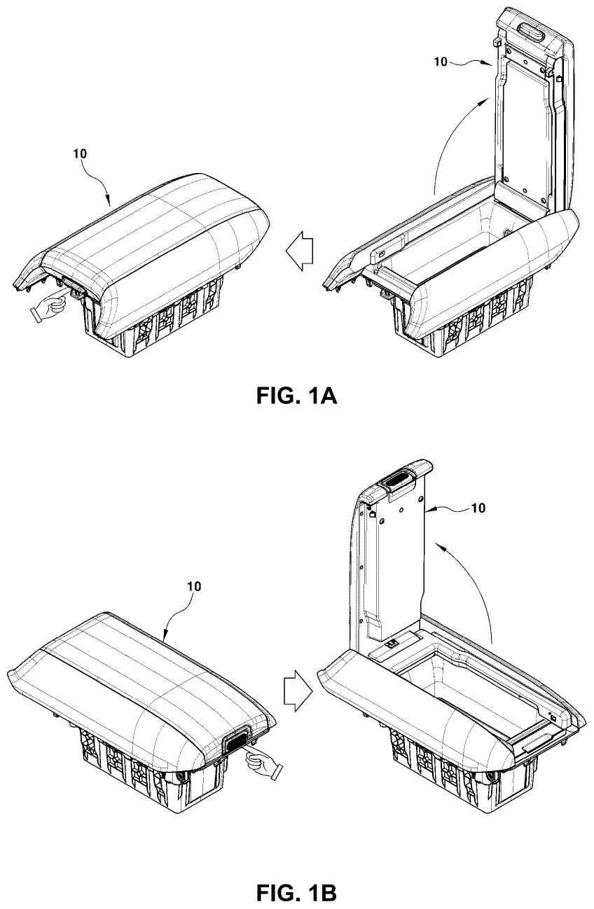

First, FIG. 1A is a view showing the console 10 that is opened with respect to the front end of the center lid part 500, and FIG. 1B is a view showing the console 10 that is opened with respect to the rear end of the center lid part 500.

The console 10 of the present disclosure may be located in the interior of a vehicle and is configured to have at least one or more partitioned spaces formed therein. Furthermore, the console 10 of the present disclosure is configured such that the center lid part 500 located on the upper surface of the console is rotatably opened. The center lid part 500 has one end hinged to the side lid parts 400 respectively located on opposite sides of an upper end of a storage space of the console 10, and the other end of the center lid part 500 is rotatably moved upwards to open the console 10. In addition, as shown in FIG. 1, when a button unit 100 located at one end of the console 10 or the other end thereof is pressed so as to open one end or the other end of the console 10, the center lead part 500 in the pressed direction is configured to be rotatably opened. According to the present disclosure, since both ends of the console 10 is openable, the button unit 100 is also located at the other end of the console 10 opposite one end thereof. In this manner, the console 10 may be opened in the other direction as well.

Meanwhile, the console 10 of the present disclosure includes the button unit 100 respectively located at the front end and the rear end of the center lead part 500, a rod unit 200 configured to be moved in the longitudinal direction of the side lead part 400 in response to the input applied to the button unit 100, and a locking cam unit 300 coupled to the rod unit 200 and configured to be rotated by movement of the rod unit 200. In addition, the center lead part 500 includes a first lock member 510 and a second lock member 520 configured to lock or unlock the side lead part 400 and the center lead part 500. The first lock member 510 is located at the front end of the console 10 and performs a function of locking or unlocking the side lead part 400 and the center lead part 500 by operation of the button unit 100, and the second lock member 520 is located at the rear end of the console 10 and performs a function of locking or unlocking the side lead part 400 and the center lead part 500.

More preferably, one end of each of the first and second lock members 510 and 520, which is fixed to the side lead part 400, is released from the side lead part 400 in response to longitudinal movement of the center lead part 500 of the rod unit 200. In addition, for example, when one end of the first lock member 510 is released from the side lead part 400 such that the fixed state of one end of the center lead part 500 is released, the center lead part 500 may be rotated around the rotational axis of one end of the second lock member 520 which is fixed to the side lead part 400.

In addition, one end of the first lock member 510, which is inserted into the side lead part 400, may be released therefrom in response to longitudinal movement of a slider 230. Here, the slider 230 is configured to be moved integrally with a first rod 210 in response to longitudinal movement of the first rod 210. Therefore, when the first rod 210 is moved in the longitudinal direction of the center lead part 500, the slider 230 is moved integrally with the first rod 210 in the longitudinal direction, and the first lock member 510 coupled to the slider 230 is moved to be inserted into the inside of the center lead part 500. A protrusion of the first lock member 510 is inserted into the inside of a guide groove diagonally formed in the slider 230. When the slider 230 is moved integrally with the first rod 210 in the longitudinal direction, the protrusion is moved to a position close to a central portion of the center lead part 500, and the first lock member 510 is configured to be released from the side lead member 400.

Furthermore, the second lock member 520 is directly coupled to a second rod 220, and one end thereof inserted into the side lead member 400 in response to longitudinal movement of the second rod 220 may be introduced into the center lead part 500.

In this manner, each of the lock members 510 and 520 respectively located at the front end and the rear end of the center lead part 500 may be selectively coupled to or released from the side lead part 400 in response to longitudinal movement of the rod unit 200 coupled to the button unit 100.

In addition, the locking cam unit 300 is configured to be rotated in response to longitudinal movement of the rod unit 200, and movement is restricted so that the input applied to the rod unit 200 that does not perform longitudinal movement is not applied. Through this configuration, when one end of the console is opened, a coupled state between the lock member located at the other end of the console and the side lead part 400 may be maintained.

In addition, the locking cam unit 300 and the rod unit 200 may be selectively coupled to each other. When one end of the console is opened, the locking cam unit 300 performs a function of fixing the rod unit 200 located at the other end of the console, and this function will be described in detail when the locking cam unit is described.

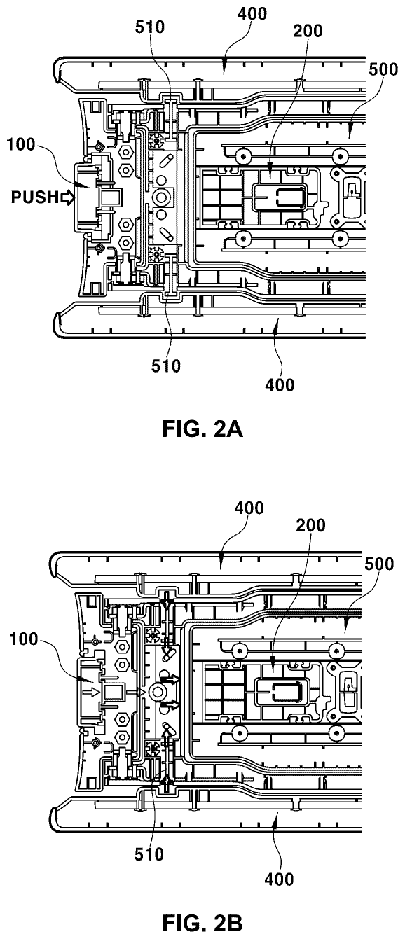

Referring to FIG. 2(A and FIG. 2B, when an open input is applied in the direction of the front end of the console 10 according to the embodiment of the present disclosure, the rod unit 200 and the slider 230 are moved to the inside of the side lead part 500, the first lock member 510 located between the side lead part 400 and the center lead part 500 are moved integrally with the slider 230, and the first lock member 510 is moved toward the central portion of the console 10, thereby releasing a locked state between the side lead part 400 and the center lead part.

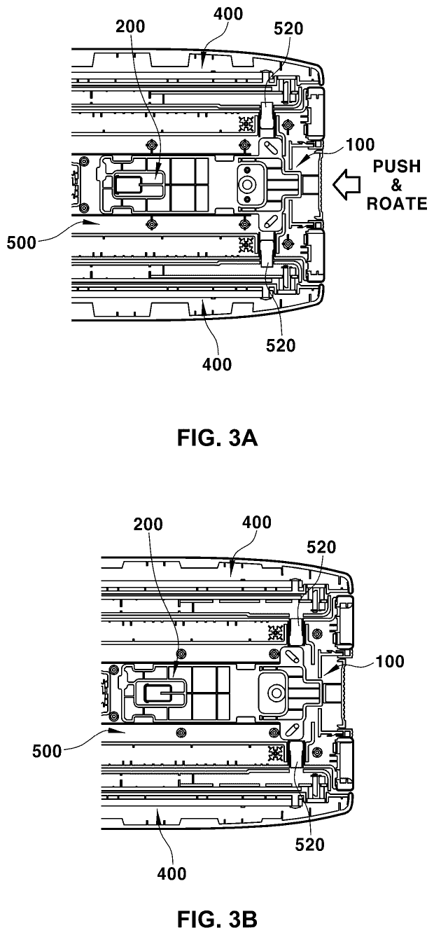

Conversely, referring to FIG. 3A and FIG. 3B, when an open input is applied to the rear end of the console 10 according to the embodiment of the present disclosure, the second rod 220 of the rod unit 200 is moved toward the central portion of the console 10, and the second lock member 520 located between the side lead part 400 and the center lead part 500 is moved toward the central portion of the console 10, thereby releasing a locked state between the side lead part 400 and the center lead part 500.

In this manner, each of the first lock member 510 and the second lock member 520 that connect the center lead part 500 to the side lead part 400 is moved toward the central portion of the console 10, thereby achieving a structure in which the front end or the rear end of the console 10 is selectively opened and closed.

Meanwhile, the button unit 100 according to the embodiment of the present disclosure includes the slider 230 located at the front end of the console 10, a first lock housing 120, a first rod lock 130, a first elastic member 140, and a rod lock member 150.

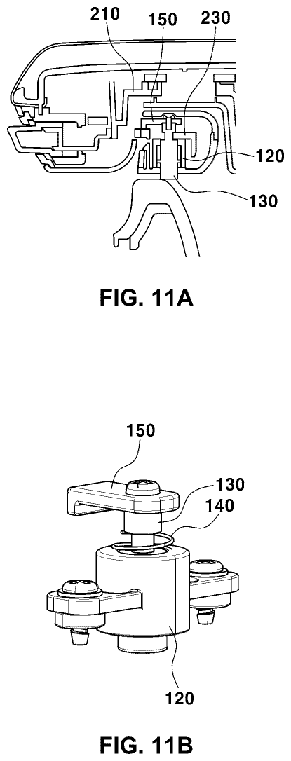

Referring to FIG. 2A, FIG. 2B, FIG. 11A, and FIG. 11B, the slider 230 of the rod unit 200 according to the embodiment of the present disclosure has a groove formed in one surface thereof, and the first rod lock 130 is inserted into and released from the groove. Specifically, a hollow is formed in the first lock housing 120 of the button unit 100 of the present disclosure, and the first rod lock 130 is inserted into the hollow and is located therein. In addition, the first elastic member 140 is located between the outer circumferential surface of the first rod lock 130 and the first lock housing 120 to impart elasticity so that the first rod lock 130 is moved downwards.

Additionally, the slider 230 is moved along the longitudinal direction of the center lead part 500 in response to the input applied to the button unit 100, and the first rod lock 130 may be moved downwards by elastic force of the first elastic member 140. More preferably, the first rod lock 130 may be inserted into the groove formed in the lower surface of the slider 230 and may protrude through the rear surface of the center lead part 500.

Furthermore, as described above, the first rod lock 130 protrudes from the lower surface of the slider 230 and the rear surface of the center lead part 500 so as to fix the slider 230. When the console 10 is closed, the first rod lock 130 is configured to face the upper surface of the housing of the console 10 such that the protruding first rod lock 130 is restored.

In this manner, the first rod lock 130 maintains a state in which elastic force is applied downwards by the first elastic member 140. When the slider 230 is moved such that the groove and the first rod lock 130 face each other, the slider 230 may be inserted into the groove so as to restrain movement of the slider 230. Furthermore, when the opened end is closed, the end of the first rod lock 130 protruding outwards from the groove comes into contact with the console 10, the first rod lock 130 is restored, and the slider 230 is located to be freely moved.

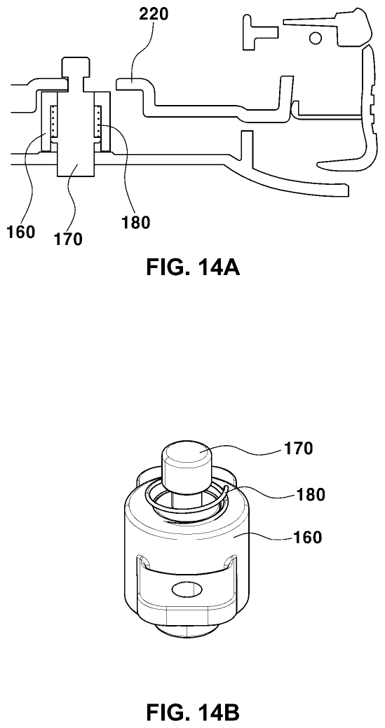

The button unit 100 located at the rear end of the console 10 according to the embodiment of the present disclosure includes a second lock housing 160, a second rod lock 170, and a second elastic member 180. Referring to FIG. 3A, FIG. 3B, FIG. 14A, and FIG. 14B, the button unit 100 located at the rear end of the console 10 has a structural configuration in which the second rod lock 170 is directly fitted to the second rod 220 of the rod unit 200, which is different from a structural configuration of the button unit 100 located at the front end. Specifically, the button unit 100 located at the rear end and the second rod 220 of the rod unit 200 are located in direct contact with each other, thereby achieving a structure in which the open input of the button unit 100 is directly applied thereto.

The second lock housing 160 of the button unit 100 of the present disclosure has a hollow formed therein, and the second rod lock 170 is inserted into the hollow and is located therein. Here, the second elastic member 180 is located around the outer circumferential surface of the second rod lock 170 and imparts elasticity, thereby moving the second rod lock 170 downwards. Specifically, a circular groove is formed in the second rod 220 of the rod unit 200, thereby allowing one side of the second rod lock 170 to be inserted into and located in the circular groove. In this manner, the second rod lock 170 is inserted into the circular groove and is fixed therein while moving downwards. For example, at least one circular groove having a width equal to or wider than the diameter of the second rod lock 170 is formed in the second rod 220. Here, when the second rod lock 170 is moved from a groove having the same diameter as that of the second rod lock 170 to a circular groove having a diameter wider than that of the second rod lock 170 and then is inserted into the circular groove, the second rod lock 170 of the button unit 100 is fixed to the second rod 220.

In this manner, movement of the second rod 220 is fixed in the longitudinal direction by the second rod lock 170, thereby enabling the second lock member 520 to maintain a state of being inserted into the inside of the center lead part 500 in a state in which the other end of the center lead part 500 is opened.

Furthermore, when elastic force of the second rod lock 170 is applied downwards by elastic force of the second elastic member 180 such that the second rod 220 is moved in the longitudinal direction of the center lead part 500 in response to the input applied to the button unit 100, the second rod lock 170 is inserted into the groove located in the rear surface of the center lead part 500 so as to protrude along the rear surface of the center lead part 500.

Furthermore, the second rod lock 170 includes a neck portion and an upper end portion, and the upper end portion is configured to have a wider width that that of the neck portion. In addition, a diameter of a groove of the second rod 220 facing the upper end portion of the second rod lock 170 in a state in which the input is not applied to the button unit 100 is configured to be smaller than a diameter of a groove facing the upper end portion of the second rod lock 170 in a state in which the second rod 220 is slidably moved. Therefore, the upper end portion of the second rod lock 170 formed to have a cylindrical shape faces a wide diameter in a state in which the second rod 220 is slidably moved and, as such, the upper end portion of the second rod lock 170 may be moved downwards along the inner side of the groove of the second rod 220. Therefore, the second rod lock 170 may restrict the longitudinal movement of the second rod 220.

In addition, a lower end portion of the second rod lock 170, which protrudes from the rear surface of the center lead part 500, may be restored to face the housing of the console 10, and the second rod 220 may be returned to a position at which longitudinal movement thereof may be freely performed.

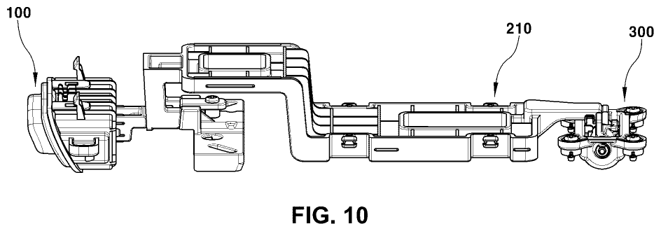

For reference, fixing structures of the button units 100 respectively located at the front end and the rear end of the console 10 will be specifically described later with reference to FIG. 10.

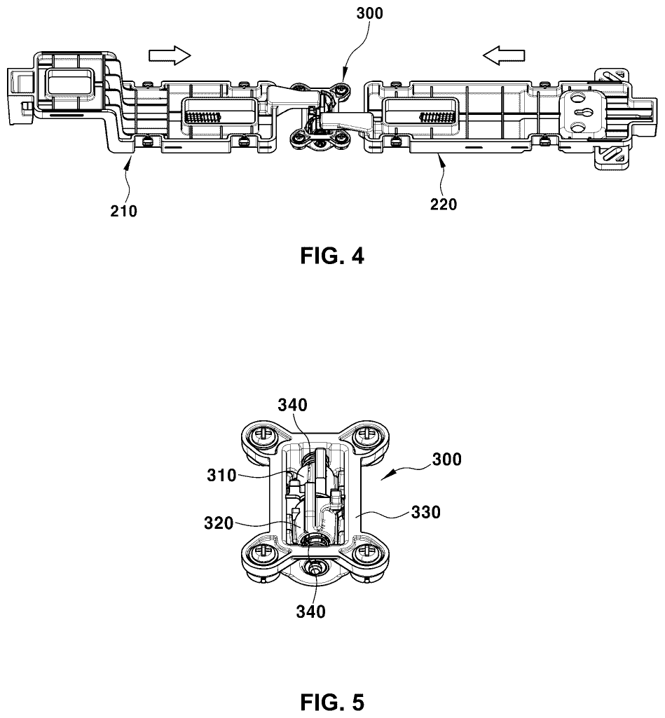

Referring to FIG. 4, the rod unit 200 of the present disclosure includes the first rod 210 and the second rod 220. The first rod 210 of the rod unit 200 is located at the front end of the console 10 and is coupled to the button unit 100 and the locking cam unit 300. In addition, the first rod 210 is operated in the longitudinal direction of the side lead part 400 and performs rotation of the locking cam unit 300 by operation of the button unit 100.

Next, the second rod 220 of the rod unit 200 is located at the rear end of the console 10 and is coupled to the button unit 100 and the locking cam unit 300. The second rod 220 is operated in the longitudinal direction of the side lead part 400 and performs rotation of the locking cam unit 300 by operation of the button unit 100.

In addition, unlike the first rod 210 coupled to the slider 230, the second rod 220 is directly coupled to the button unit 100 pressed by a user. Accordingly, when the button unit 100 is pressed, the second rod 220 is immediately operated.

Meanwhile, regarding the first rod 210 and the second rod 220 of the rod unit 200, a first groove 211 is formed in the first rod 210, and a first locking member 311 of a first locking cam 310 to be described later is inserted into and coupled to the first groove 211. A second groove 221 is formed in the second rod 220, and a second locking member 321 of a second locking cam 320 to be described later is inserted into and coupled to the second groove 221.

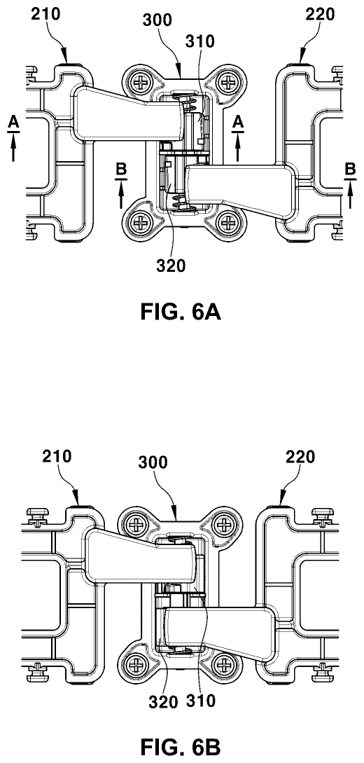

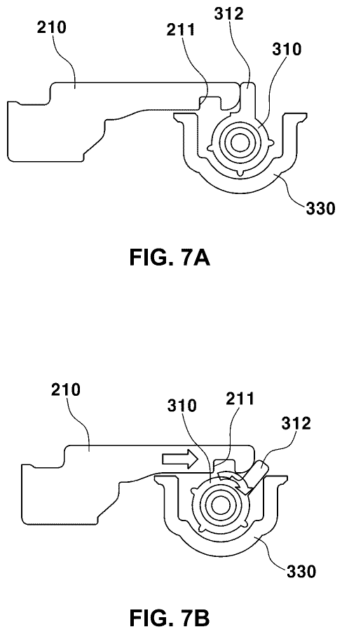

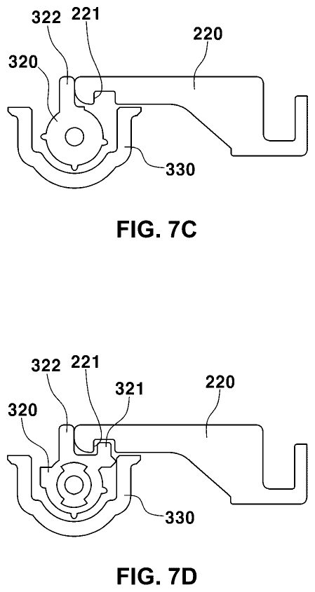

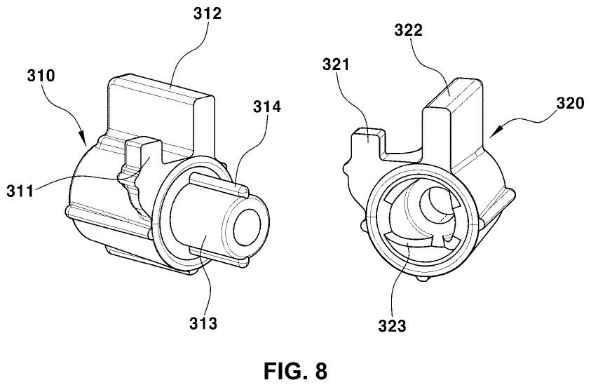

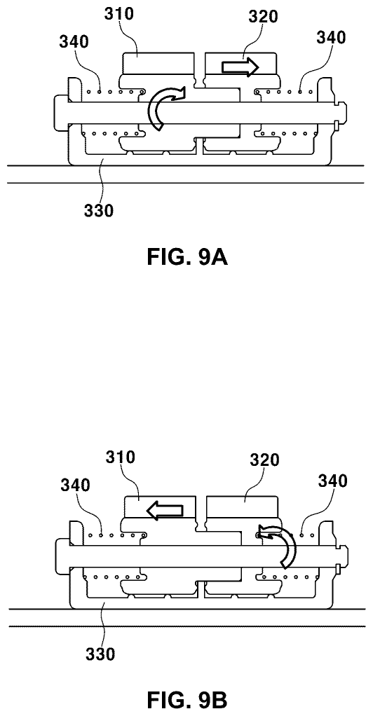

Referring to FIGS. 5 to 9, the locking cam unit 300 of the present disclosure includes the first locking cam 310, the second locking cam 320, a locking cam housing 330, and a cam spring 340.

First, the first locking cam 310 includes the first locking member 311, a first step 312, an extension member 313, and a protrusion 314. The first locking member 311 and the first step 312 of the first locking cam 310 are formed to protrude from the outer circumferential surface of the first locking cam 310 by a predetermined amount. The first locking member 311 is provided on the outer circumferential surface of the first locking cam 310 in the width direction so as to be selectively coupled to the first rod 210, and the first step 312 is formed to convert movement of the first rod 210 into rotational motion of the first locking cam 310 in response to the longitudinal movement of the console 10. In addition, the extension member 313 of the first locking cam 310 is formed to extend toward the inner circumferential surface of the second locking cam 320 by a predetermined amount. The extension member 313 of the first locking cam 310 may be formed to have the same shape as that of the inner surface of the second locking cam 320 in order to be inserted into the inner surface of the second locking cam 320. Additionally, the protrusion 314 of the first locking cam 310 is formed to protrude from the outer circumferential surface of the extension member 313 of the first locking cam 310 and is formed to be coupled to a diagonal groove 323 of the second locking cam 320. In other words, the locking cam unit 300 is not constantly coupled to the rod unit 200, and more specifically, the locking cam unit 300 is coupled to the rod unit 200 so as to fix the other end thereof in a state in which one end thereof is opened, thereby performing a function of selectively fixing one end or the other end.

Meanwhile, driving of the first locking cam 310 of the present disclosure is performed in such a manner that, when the first rod 210 pushes the first step 312 of the first locking cam 310, the first locking cam 310 is rotated, and the second locking cam 320 coupled to the protrusion 314 of the extension member 313 of the first locking cam 310 is moved outwards from the center in the width direction. Moreover, the second locking member 321 is located in the second groove 221 formed in the second rod 220 to restrict longitudinal movement of the second rod 220.

Conversely, when the second rod 220 is pushed in the longitudinal direction of one end of the console 10, the first locking cam 310 is moved away from the second locking cam 320, and the first locking member 311 of the first locking cam 310 is moved integrally with the first locking cam 310 in the width direction, so that the first locking member 311 is coupled to the first groove 211 of the first rod 210.

Therefore, movement of the remaining rods respectively located at the other ends of the two rods 210 and 220 performing longitudinal movement may be restricted by the locking unit 300.

The second locking cam 320 of the present disclosure is formed of the second locking member 321, a second step 322, and the diagonal groove 323.

The second locking member 321 and the second step 322 of the second locking cam 320 are formed to protrude from the outer circumferential surface of the second locking cam 320 by a predetermined amount. The second locking member 321 and the second step 322 may be formed to have the same shape as that of the first locking member 311 and the first step 312 of the first locking cam 310. In addition, the second locking member 321 is provided to be coupled to the second rod 220, and the second step 322 is formed to convert movement of the first locking cam 310 into widthwise movement when the second rod 220 is pushed.

Additionally, driving of the second locking cam 320 of the present disclosure is performed in such a manner that, when the user pushes the button unit 100 in the front direction of the console 10, the second rod 220 is moved in the longitudinal direction along the inside of the console, and the second locking cam 320 is rotated by rotational driving of the second step 322.

That is, when the first rod 210 is pushed toward the rear end of the console 10 by the button unit 100, the first locking cam 310 is rotated, and the second locking cam 320 coupled to the first locking cam 310 is configured to move in the width direction, thereby achieving a structure in which the second locking member 321 is moved integrally with the second locking cam 320 such that the second locking member 321 is fixedly coupled to the second groove 221 of the second rod 220.

Conversely, when a user presses the button unit 100 located in the direction of the rear end of the console 10, the second rod 220 is pushed in the direction of the front end of the console 10, and the second locking cam 320 coupled to the second rod 220 is rotated. In this state, the first locking cam 310 is moved in a direction away from the second locking cam 320, and the first locking member 311 of the first locking cam 310 is coupled to the first groove 211 of the first rod 210.

In this manner, in response to rotation of the first locking cam 310, the second locking cam 320 is moved in the width direction away from the first locking cam 310, and the second groove 221 located in the second rod 220 and the second locking member 321 are moved to a position at which the second groove 221 and the second locking member 321 are coupled to each other.

On the contrary, in response to rotation of the second locking cam 320, the first locking cam 310 is moved in the width direction away from the second locking cam 320, and the first groove 211 located in the first rod 210 and the first locking member 311 are moved to a position at which the first groove 211 and the first locking member 311 are coupled to each other.

That is, when one of the two button units 100 respectively located at opposite ends of the center lead part 500 is pressed, sliding movement of a rod coupled to the other end of the button unit 100 is controlled through the locking cam unit 300. In this manner, even if the center lead part 500 is opened and closed using the button unit 100 located in the direction of one end of the console 10, the other end of the console 10 is configured to be locked through a coupling structure of the first locking cam 310 and the second locking cam 320, thereby achieving the console 10 capable of being opened and closed in one direction.

In addition, the first locking cam 310 and the second locking cam 320 of the present disclosure may be coupled to the cam spring 340. When the first locking cam 310 and the second locking cam 320 are rotated, the cam spring 340 provides elastic force to restore the first locking cam 310 and the second locking cam 320 in a direction in which the first locking cam 310 and the second locking cam 320 contact each other by tension of the cam spring 340. Additionally, the locking cam housing 330 of the present disclosure serves to house the first locking cam 310, the second locking cam 320, and the cam spring 340.

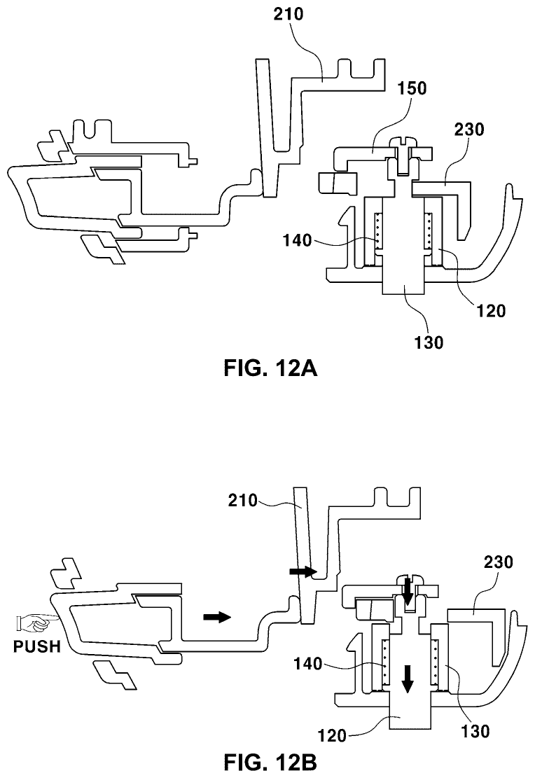

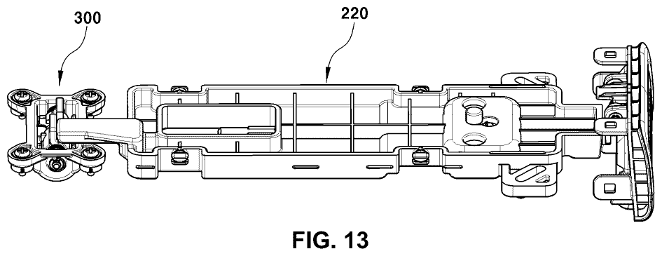

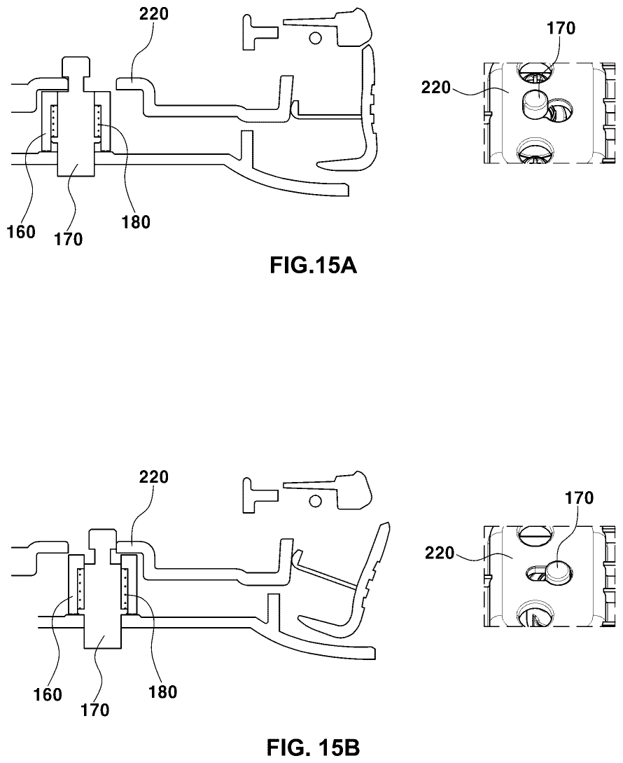

Referring to FIGS. 10 to 15, a description will be specifically given as to an opening/closing and locking structure of the console 10 when an open input is applied to any one of the button units 100 respectively located at the front end and the rear end of the console 10 according to the embodiment of the present.

First, when the open input is applied to the button unit 100 located at the front end of the console 10 according to the embodiment of the present disclosure, the slider 230 of the rod unit 200 pushes the first rod 210 of the rod unit 200 toward the center of the console 10, and the first lock member 510 located between the side lead part 400 and the center lead part 500 is released, thereby performing an opening/closing operation of the console 10 located at the front end.

In addition, when the button unit 100 located in the direction of the front end of the console 10 is operated, the first rod 210 and the slider 230 of the rod unit 200 are moved in the operating direction. When the slider 230 of the rod unit 200 is moved, the first rod lock 130 is moved downwards by tension of the first elastic member 140, and the first rod lock member 150 coupled to the upper end of the first rod lock 130 is integrally moved downwards. The first rod lock member 150 extends in a direction corresponding to the adjacent button unit 100 and has a hook shape in which one end adjacent to the button unit 100 is bent downwards. Therefore, the first rod lock 130 and the first rod lock member 150 are integrally moved downwards in response to the input applied to the button unit 100, and the first rod lock member 150 is coupled to a locking jaw of the first rod 210. As such, the first rod lock 130 and the first rod lock member 150 restrict movement of the first rod 210 and the slider 230 in a state in which the front end of the center lead part 500 is opened, thereby maintaining a state in which the first lock member 510 is inserted into the center lead part 500.

Moreover, the upper end of the first rod lock 130 is formed of the neck portion and the upper end portion, and the upper end portion is formed to have a larger width than that of the neck portion. Therefore, when the first rod 210 is slidably moved, the slider 230 moved integrally with the first rod 210 is moved in the longitudinal direction of the center lead part 500, and the upper end portion of the first rod lock 130 is configured to be released from coupling with the slider 230 and to be moved downwards toward the inside of the first lock housing 120. In addition, the first rod lock 130 that is moved downwards is configured to be inserted into the groove located in the rear surface of the slider 230.

Therefore, the first rod lock 130 integrally fixes the first rod 210 and the slider 230 in response to the input applied to the button 100 and is disposed to protrude from the rear surface of the center lead part 500. Therefore, after the button unit 100 is operated, the first rod 210 maintains a fixed state thereof. In the case of releasing the fixed state of the first rod 210, when the console 10 is closed, one end of the first rod lock 130 protruding from the rear surface of the center lead part 500 is moved upwards while contacting the storage box, thereby releasing movement restriction of the first rod 210.

When the open input is applied to the button unit 100, the first rod 210 is moved in the longitudinal direction of the center lead part 500, the first locking cam 310 coupled to the first rod 210 is rotated, and the first rod 210 coupled to the first locking cam 310 is locked by the first rod lock 130 and the first rod lock member 150. In addition, when the center lead part 500 adjacent to the end of the first rod part 210 is opened, the second rod 220 maintains a state of being fixed to the locking cam unit 300 in response to movement in the width direction of the second locking cam 320 coupled to the first locking cam 310.

Moreover, when the first rod 210 located in the direction of the front end of the console 10 is moved in the longitudinal direction of the center lead part 500, the first locking cam 310 coupled to the first rod 210 of the rod unit 200 is rotated in a direction corresponding to the longitudinal direction of the first rod 210, and the second locking cam 320 coupled to the protrusion 314 of the first locking cam 310 is linearly moved in the width direction away from the first locking cam 310. Accordingly, the first locking cam 310 and the second locking cam 320 are spaced apart from each other. That is, the second locking cam 320 is moved outwards in the width direction from the center of the locking cam housing 300. Thereafter, the second locking member 321 of the second locking cam 320 is inserted into the second groove 221, thereby restricting longitudinal movement of the button unit 100 coupled to the second rod 220.

Conversely, when the open input is applied to the button unit 100 located at the rear end of the console 10 according to the embodiment of the present disclosure, the button unit 100 located at the rear end of the console 10 pushes the second rod 220 of the rod unit 200 toward the center of the console 10, and the second lock member 520 of the center lead part 500, which is located between the side lead part 400 and the center lead part 500, is moved in the direction of the second rod 220. Accordingly, one end of the center lead part 500 to which the button input is applied is unlocked, and the rear end of the console 10 may be opened and closed.

Here, when the second rod 220 of the rod unit 200 is pushed in the direction of the front end of the console 10, the second step 322 of the second locking cam 320 coupled to the second rod 220 is rotated counterclockwise, and the second locking cam 320 is rotated counterclockwise, thereby allowing the first locking cam 310 coupled to the second locking cam 320 to be moved toward the outside of the locking cam housing 330 in the width direction. The first locking cam 310 moved in this manner is configured to restrict movement of the first rod 210 by moving the first locking member 311 toward the inside of the first groove 211.

In this manner, the present disclosure provides a bidirectional opening console configured to restrict, in response to an input applied to one of the button units 100 respectively located at the front and rear ends of the center lead part 500, movement of a rod located at the other end of the center lead part 500 through the locking cam unit 300 in a state in which one end of the center lead part 500 is opened, thereby maintaining a hinge structure of the other end of the center lead part 500.

As is apparent from the above description, the present disclosure provides the following effects through the above-described configuration, combination, and usage relationship.

The present disclosure provides a vehicle console configured to stably fix, when a front side of the console is opened, a rear side of the console, and to stably fix, when the rear side of the console is opened, the front side of the console, thereby preventing the console from being simultaneously opened at the front side and the rear side of the console and enabling a passenger to conveniently open the console from the front side or the rear side.

Further, the present disclosure provides a vehicle console capable of being opened and closed in both directions with a simple configuration and simple components, thereby optimizing a structure of the vehicle console and improving aesthetics of the exterior of the vehicle console.

The present disclosure has been described in detail with reference to preferred embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well

What is claimed is:

1. A bidirectional opening console comprising:
a first side lid part located on a first side of the bidirectional opening console and a second side lid part located on a second side of the bidirectional opening console, the first side being opposite the second side;
a center lid part located between the first side lid part and the second side lid part, wherein the center lid part is opened at one end;
a first button unit located at a front end of the center lid part and a second button unit located at a rear end of the center lid part;
a rod unit configured to be moved in a longitudinal direction of the first and second side lid parts in response to an input applied to one of the first and second button units;
a lock member unit located at the center lid part and configured to release coupling with each of the first and second side lid parts in response to movement of the rod unit; and
a locking cam unit configured to be rotated by the movement of the rod unit;
wherein the lock member unit is positioned at the other end of the center lid part maintains a coupled state by rotation of the locking cam unit, wherein the other end is located away from the button unit having the input applied thereto.

2. The bidirectional opening console of claim 1, wherein the first and second button units each comprise:
a first lock housing having a hollow formed therein;
a first rod lock inserted into the hollow of the first lock housing;
a first elastic member located around an outer circumferential surface of the first rod lock, and configured to impart elasticity to the first rod lock; and
a first rod lock member connected to the first rod lock and coupled to the rod unit when the first rod lock is moved downwards.

3. The bidirectional opening console of claim 2, wherein the first rod lock member is configured to fix, when one side of the bidirectional opening console is opened, the movement of the rod unit.

4. The bidirectional opening console of claim 3, wherein the first rod lock member has a hook shape and is caught by a first rod, and the first rod has a shape corresponding to a groove shape of a slider.

5. The bidirectional opening console of claim 1, wherein the rod unit comprises:
a first rod located at the front end of the center lid part of the bidirectional opening console;
a second rod located at the rear end of the center lid part of the bidirectional opening console; and
a slider configured to be moved integrally with the first rod, the slider having a groove formed in a rear surface.

6. The bidirectional opening console of claim 1, wherein the lock member unit comprises:
a plurality of first lock members located at the front end of the center lid part of the bidirectional opening console, wherein each of the plurality of first lock members is configured to be locked to or unlocked from a corresponding one of the first or second side lid parts; and
a plurality of second lock members located at the rear end of the center lid part of the bidirectional opening console, wherein each of the second lock members is configured to be locked to or unlocked from a corresponding one of the first or second side lid parts.

7. The bidirectional opening console of claim 1, wherein the locking cam unit comprises:
a first locking cam having a protrusion formed on an outer circumferential surface; and
a second locking cam configured to allow the protrusion of the first locking cam to be inserted into an inner circumferential surface of the second locking cam, the second locking cam having a groove continuously formed along the inner circumferential surface, wherein;
when the first locking cam is rotated in response to longitudinal movement of the rod unit at the front end of the center lid part of the bidirectional opening console, the second locking cam is moved in a direction away from the first locking cam, and
when the second locking cam is rotated in response to longitudinal movement of the rod unit at the rear end of the center lid part of the bidirectional opening console, the first locking cam is moved in a direction away from the second locking cam.

8. The bidirectional opening console of claim 1, wherein the locking cam unit comprises:
a locking cam housing configured to accommodate a first locking cam and a second locking cam; and
a cam spring configured to impart elasticity to the first locking cam and the second locking cam in a direction allowing the first locking cam and the second locking cam to be adjacent to each other.

9. The bidirectional opening console of claim 7, wherein the first locking cam comprises:
a first locking member protruding and extending from the outer circumferential surface of the first locking cam by a predetermined amount, and the first locking member being coupled to the rod unit;
a first step located adjacent to the first locking member, wherein the first step is configured to convert, in response to the longitudinal movement of the rod unit, movement of the first locking cam into rotational motion of the first locking cam;
an extension member located on one surface of the first locking cam and extending toward an inner side of the second locking cam; and
a protrusion protruding from an outer circumferential surface of the extension member.

10. The bidirectional opening console of claim 9, wherein the second locking cam comprises:
a second locking member protruding and extending from an outer circumferential surface of the second locking cam by a predetermined amount, and the second locking member coupled to the rod unit;
a second step located adjacent to the second locking member, wherein the second step is configured to convert, in response to the longitudinal movement of the rod unit, movement of the second locking cam into rotational motion of the second locking cam; and
a diagonal groove configured to contact the protrusion of the extension member and extending in a diagonal direction along the inner circumferential surface of the second locking cam.

11. The bidirectional opening console of claim 5, wherein:
when the protrusion is rotated along the diagonal groove, the second locking cam is moved in a width direction away from the first locking cam; and
the second locking member is coupled to a second groove located in the second rod so as to restrict movement of the second rod.

12. The bidirectional opening console of claim 5, wherein:
when the second locking cam is rotated, the protrusion is moved integrally with the first locking cam along the diagonal groove in a width direction away from the second locking cam, and
the first locking member is coupled to a first groove located in the first rod so as to restrict movement of the first rod.

13. The bidirectional opening console of claim 5, wherein the second rod is in contact with the first and second button units.

14. The bidirectional opening console of claim 1, wherein the each of the first and second button units comprise:
a second lock housing positioned at a rear end of the bidirectional opening console, the second lock housing having a hollow formed therein;
a second rod lock inserted into the hollow of the second lock housing; and
a second elastic member located on an outer circumferential surface of the second rod lock and configured to impart elasticity to the second rod lock;
wherein the rod unit has a groove formed therein and is configured to allow one side of the second rod lock to be inserted thereinto, and the second rod lock is moved downwards by the elasticity of the second elastic member so as to be fixedly inserted into the groove.
